(19) United States
(12) Patent Application Publication
(10) Pub. No.: US 2014/0344128 A1
(43) Pub. Date: Nov. 20, 2014

(54) FINANCIAL DISTRESS RATING SYSTEM

(71) Applicant: RAWLLIN INTERNATIONAL INC., Tortola (VG)

(72) Inventors: Andrey Nikankin, Saint-Petersburg (RU); Aleksey Shaternikov, Saint-Petersburg (RU)

(21) Appl. No.: 13/893,587

(22) Filed: May 14, 2013

(51) Int. Cl. G06Q 40/00

(52) U.S. Cl. CPC G06Q 40/00
USPC 705/35

(57) ABSTRACT

A financial distress rating system is provided to forecast potential episodes of financial risk. The financial distress rating system can also predict the probability of financial distress at certain times. The financial distress rating system can utilize mobile operator data as well as transaction history of the user to predict with much greater accuracy than profiling methods alone. The forecasts of financial distress can be used to assess the risk of delayed payments (e.g., to the mobile operator, creditors, utilities, services, banks, etc). The forecasts of financial distress can also be used to market goods and services to the customer based on the financial distress rating. For instance, overdraft protection, short term loans, and other financial services can be offered to customers that are facing a period of financial distress.

### TECHNICAL FIELD

The subject disclosure relates generally to forecasting financial distress and risk management.

### BACKGROUND

Forecasts of financial distress and potential financial risk are used to assess the risk of possible missed payments, assign interest rates for loans and payments, and to offer new products and services. Current financial risk models attempt to place customers and clients into one or more risk profiles based on self reported information and other publicly available information such as credit reports. These risk models broadly predict patterns of risk and financial distress but are not highly accurate, especially with regards to predicting when a person might experience financial distress.

The above-described description is merely intended to provide a contextual overview of financial risk determination, and is not intended to be exhaustive.

### SUMMARY

Various non-limiting embodiments provide for a financial distress rating system for a mobile device account. In an example embodiment, a system comprises a memory to store computer-executable instructions and a processor communicatively coupled to the memory which facilitates execution of the computer-executable instructions. The computer-executable instructions can include instructions to receive location data associated with a mobile device account and determine contextual information based on the location data. There are also instructions to receive transaction information associated with the mobile device account and to determine a financial distress rating for the mobile device account based on the transaction information and the contextual information.

In another example embodiment, a method comprises receiving, by a system comprising at least one processor, location history data representing a location history of a mobile device associated with a mobile device account. The method can also include determining, by the system, contextual information based on the location history data and collecting, by the system, transaction history data representing a transaction history associated with the mobile device account. The method also includes determining, by the system, a financial risk rating for the mobile device account based on the transaction history and the contextual information.

In another example embodiment, a tangible computer-readable storage device has computer-executable instructions that, in response to execution, cause a system comprising a processor to perform operations comprising storing location data associated with a mobile device account, wherein the location data is representative of a location history of a mobile device associated with the mobile device account. The operations also include receiving a transaction history from the mobile device representing a set of transaction initiated during usage of the mobile device and generating a profile of a user identity associated with the mobile device account based on the location data and the transaction history. The operations also include forecasting a probability of financial risk based on the transaction history and the profile.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an example, non-limiting embodiment of a financial distress calculation system in accordance with various aspects described herein;

FIG. 2 is a block diagram illustrating an example, non-limiting embodiment of a financial distress calculation system in accordance with various aspects described herein;

FIG. 3 is a block diagram illustrating an example, non-limiting embodiment of a mobile device location system in accordance with various aspects described herein;

FIG. 4 is a block diagram illustrating an example, non-limiting embodiment of an exemplary profile table that facilitates making financial distress forecasts in accordance with various aspects described herein;

FIG. 5 is a block diagram illustrating an example, non-limiting embodiment of system that issues warnings and makes offers based on a financial distress rating in accordance with various aspects described herein;

FIG. 6 illustrates a flow diagram of an example, non-limiting embodiment of a method for forecasting financial distress as described herein;

FIG. 7 illustrates a flow diagram of an example, non-limiting embodiment of a method for forecasting financial distress as described herein;

FIG. 8 illustrates a block diagram of an example electronic computing environment that can be implemented in conjunction with one or more aspects described herein;

FIG. 9 illustrates a block diagram of an example data communication network that can be operable in conjunction with various aspects described herein; and

FIG. 10 illustrates a block diagram of an example mobile network platform that can be operable in conjunction with various aspects described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the disclosure, as generally described herein, and illustrated in the Figures, can be arranged, substituted, combined, separated, and designed in a wide variety of different configurations, all of which are explicitly contemplated herein.

In various non-limiting embodiments, a financial distress rating system is provided to forecast potential episodes of financial risk. The financial distress rating system can also predict the probability of financial distress at certain times. The financial distress rating system can utilize mobile operator data as well as transaction history of the user to predict with much greater accuracy than profiling methods alone. The forecasts of financial distress can be used to assess the risk of delayed payments (e.g., to the mobile operator, creditors, utilities, services, banks, etc). The forecasts of financial distress can also be used to market goods and services to the customer based on the financial distress rating. For instance, overdraft protection, short term loans, and other financial services can be offered to customers that are facing a period of financial distress.

In various non-limiting embodiments, the financial distress rating system can use mobile operator data to forecast financial risk. The financial distress rating system can use location information to build contextual information about the user. The contextual information can include assumptions about jobs, residence location, shopping trips, shopping frequency, and etc., to build a risk model for the user. The mobile operator data can also include transaction information such as purchases and other financial transfers made over a mobile device associated with user's mobile device account. Transaction information can also include browsing and search history from the mobile device.

It is to be appreciated that in accordance with one or more implementations described in this disclosure, users can opt-out of providing personal information, demographic information, location information, proprietary information, sensitive information, or the like in connection with data gathering aspects. Moreover, one or more implementations described herein can provide for anonymizing collected, received, or transmitted data.

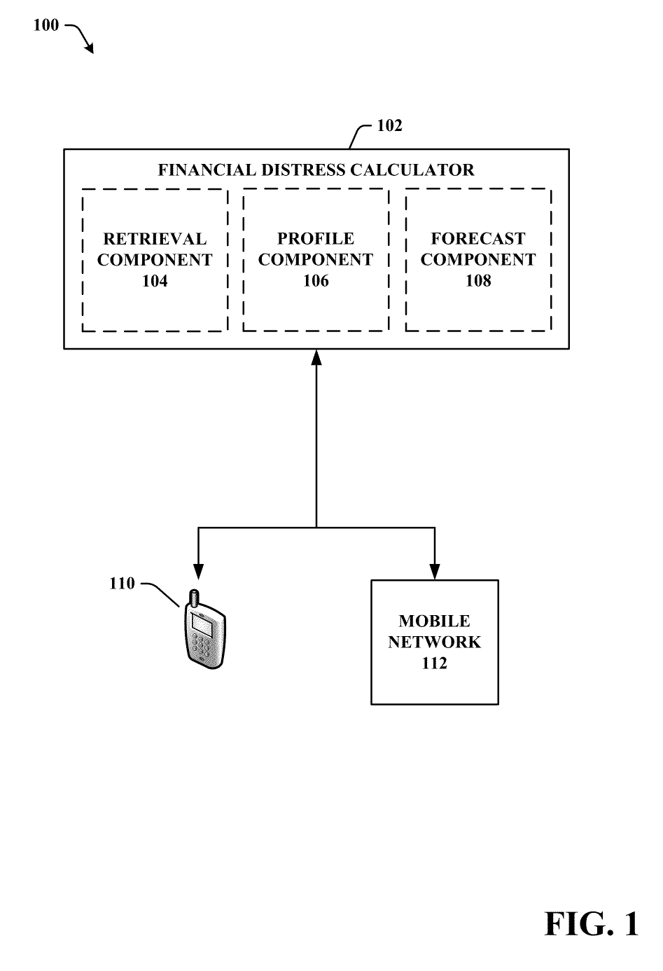

Referring now to FIG. 1, is a block diagram illustrating an example, non-limiting embodiment of a financial distress calculation system 100 in accordance with various aspects described herein is shown. System 100 includes a financial distress calculator 102 that forecasts the likelihood that a mobile device account associated with mobile device 110 will experience financial distress.

A retrieval component 104 can be configured to retrieve location data associated with the mobile device account. In some embodiments, the location data can be in the form of GPS coordinates obtained by the mobile device 110's GPS receiver. In such cases, the location data can be retrieved by retrieval component 104 from the mobile device 110. In other embodiments, the location data can be based on network locating services (e.g., triangulation using signals from cell towers). The retrieval component 104 can then receive the location data from the mobile network 112.

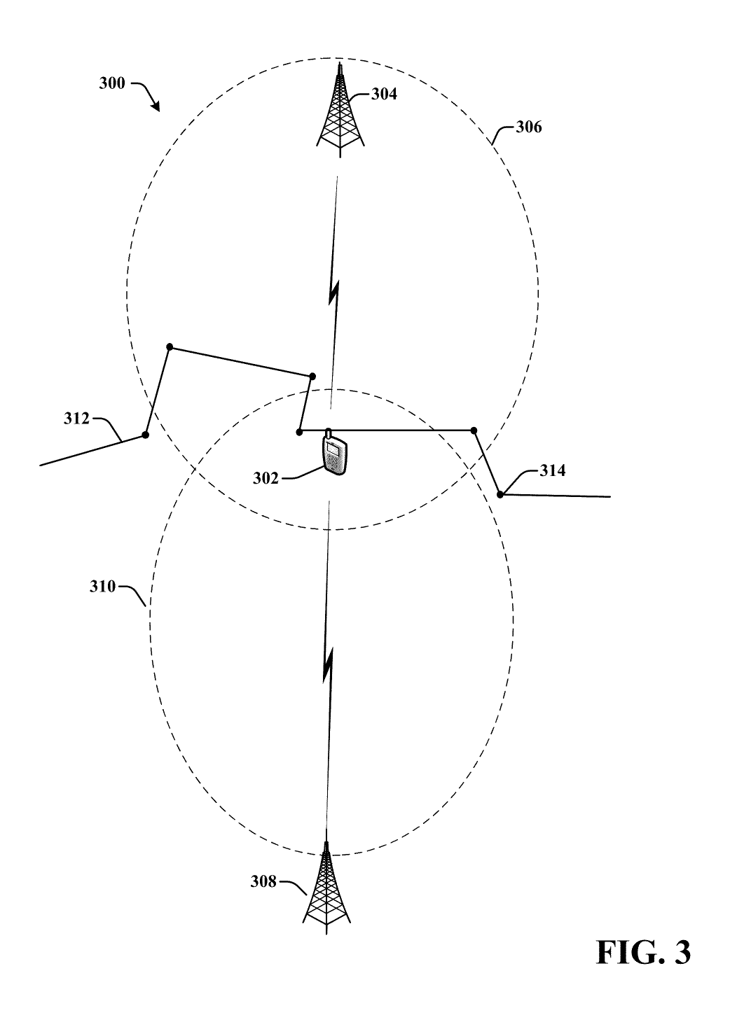

The location data can also include time stamps for each location data point. The time stamps can indicate how long the mobile device, and thus the user, spent at each location. The time stamps can be analyzed to determine the speed of the mobile device as well. If the time stamps of the location data points are sufficiently close together, and the location indicated by the location data points are different from each other, the speed of the mobile device 110 can be determined (described in more detail with regard to FIG. 3).

In some embodiments, the retrieval component 104 can retrieve the location data periodically in the form of a log file showing location and time stamps over a defined period. For instance, the retrieval component 104 can receive the location data each day or each week, and include all the location data and time stamps since the last retrieval. In other embodiments, the retrieval component 104 can receive the location data points and time stamps as they are generated, in real time or near to real time.

The granularity or accuracy of the location data is dependent on the type of method used to determine the location of the mobile device 110. In some embodiments, the location data is based on GPS measurements, and so the accuracy of the location data can be to +/−5 m. When network location services determine the location of the mobile device 110 using triangulation (or more specifically, multilateration) the accuracy of the location data is much poorer, where the mobile device 110 maybe located to within +/−400 m.

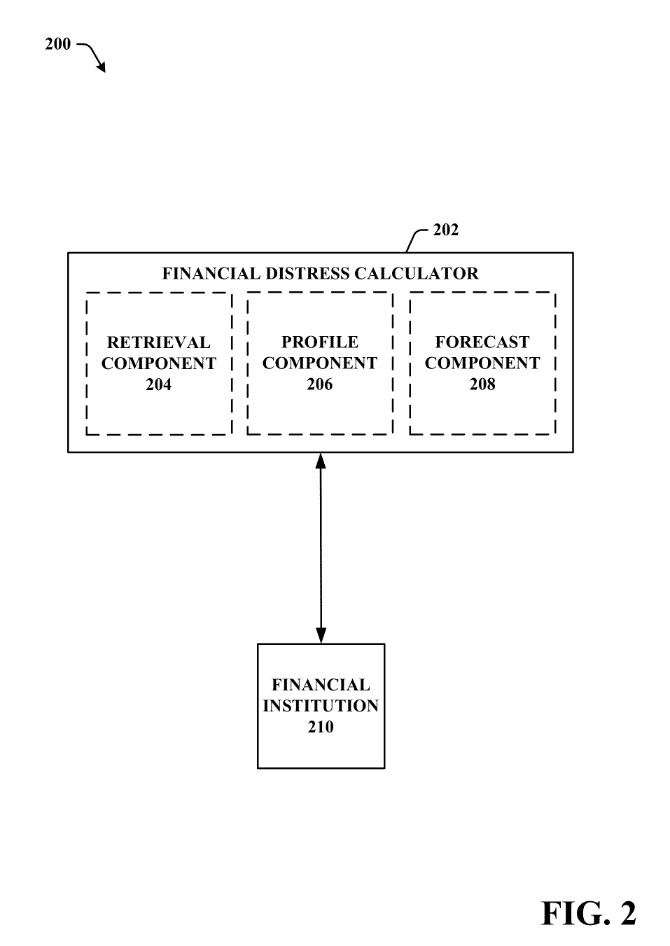

The retrieval component 104 can also retrieve transaction information associated with the mobile device account from the mobile device 110 or the mobile network 112. The transaction information can include information related to search requests made by the user, browsing history, online purchases, planned purchases, and financial institution account transfers and deposits (see e.g., FIG. 2). In some embodiments, the mobile network 112 can track the data usage made by mobile device 110 when utilizing mobile network 112, e.g., when mobile device 110 is using 3G or 4G network services. If the mobile device 110 is using Wi-Fi or some other non mobile network service internet connection, mobile device 110 can track the usage and report the usage to retrieval component 104.

The transaction history collected by retrieval component 104 can be used to track and to build a better understanding of purchasing and shopping habits by the user of the mobile device account. The transaction history can also provide some information about the expenditures made by the user as well as the user's income level.

The profile component 106 can analyze the location data and determine contextual information based on the location data. The contextual information can be assumptions made about the user of the mobile device account based on recognized patterns and other identifying information. For instance, the contextual information can include information identifying a residence of the user. The profile component 106 can determine the residence based on identifying the location where the mobile device 110 spends the night, or large periods of time at. The residential location, address, zip code, city, etc, can assist with providing estimates of the cost of the house, mortgage payments, and taxes, etc. The profile component 106 can also identify employers or employer location based on analyzing the location data. For instance, if the mobile device 110 is tracked going to and from a location other than the residence 5-6 days a week for 7-10 hours every day, the profile component 106 can determine that the user is going to and from work.

The contextual information can also include information about the user of the mobile device account relating to type of occupation, hours worked, commute length, frequency of shopping excursions, duration of shopping excursions, vacations, and etc. The profile component 106 can identify the locations of the shopping excursions and make estimates about how much money is spent and the types of shops that are visited. For instance, if the mobile device 110 is tracked to a grocery store, assumptions about expenditures will be different than if the mobile device 110 is tracked to an area with many stores selling luxury items.

In some embodiments, the profile component 106 can compare the location data to publicly available mapping data to determine where the mobile device 110 was located at the time of the location measurement. For instance, the mapping data can include roads and businesses and other places of interest overlaid over the coordinate map.

In some embodiments, profile component 106 can also look up other public and/or private databases to develop the contextual information. For instance, profile component 106 can determine the residence of the user is at a specific address by comparing the mapping data to the coordinate information in the location data. The profile component 106 can then look up the property information in the government's tax database to determine the value of the house, amount of taxes paid, outstanding taxes, and etc. Similarly, profile component 106 can identify employers, shopping locations, and other information from the location data.

In some embodiments, the profile component 106 can generate a profile of the mobile device account user or match the profile to one or more standard profiles. The profile can be based on the contextual information and also on information retrieved from the mobile device account (e.g., user provided account information). The profile can include information about the user such as gender, age, marital status, number of marriages, type of residence, location of residence, number of dependents/children, education level, income level, tendency to save/saving ratio, number of vehicles in use, and other pertinent information. Some the profile categories can be determined based on the account information, some of it can be determined based on the location and contextualization data, some of it can be determined from an analysis of the transaction history, and the rest of the categories can be assumed or extrapolated based on the rest of the profile.

In some embodiments, the profile component 106 can match the profile to one or more standard or known profiles. For instance, young, white collar, married couples with 2 children who are college educated are likely to have similar levels of income, spending history, debt load, etc. When profile component 106 identifies enough variables to identify one of the standard profiles, the profile component 106 can assume that the rest of the categories match the standard profile to make the risk modeling easier.

In other embodiments, profile component 106 can generate customized profiles that are based on the information determined and extrapolated by the profile component 106. The profiles can provide the framework of a risk model for the risk forecasting and the transaction histories can be fed into the framework to provide the probability of financial distress.

The forecast component 108 can determine the financial distress rating for the mobile device account based on the transaction information and the profile/contextual information. The financial distress rating can indicate the likelihood of the user defaulting on payments, or experiencing other forms of financial distress. The financial distress rating can also be time-based, where the forecast component 108 predicts when and for how long the period of financial distress is likely to happen. The financial distress rating can also indicate the severity or intensity of the financial distress. A lower rating may indicate that the user will merely have to make lifestyle changes to reduce costs or ‘belt-tighten’ their expenses. A higher rating may indicate that the user is likely to default on debt payments, mortgage payments, mobile device account fees, and other payments for services.

In various embodiments, forecast component 108 can analyze the transaction history or the contextual information by themselves to determine the financial distress rating. For instance, forecast component 108 can determine from contextual information alone the relative likelihood of the user entering into financial distress. If it is determined that a user is no longer employed based on the location data (i.e., no more daily trips to the employer from the house), the relative financial distress rating will be higher.

The forecast component 108 can also determine from the transaction history alone whether the risk of financial distress will increase. In some embodiments, forecast component 108 can determine the financial distress rating based on a function of the estimated monthly income and the estimated monthly expenses. By comparing the balance of funds with the rate money is being spent or gained on a weekly or monthly basis, the forecast component 108 can determine with some accuracy to within several days when the user will experience financial distress.

In one exemplary embodiment, forecast component 108 can utilize a function to predict financial distress: ESTPNL(t)=a+b*t, wherein ESTPNL is the monthly residual (burn rate) and “a” and “b” are regression coefficients of a forecast model, and “t” is the day of the month. The regression coefficients “a” and “b” are as follows:

$$a = \frac{1}{n} * ( {\sum }_{i = 1}^{n} E S T P N {L}_{i} - b * {\sum }_{i = 1}^{n} {t}_{i} ) , \\ and$$

$$b = \frac{n * {\sum }_{i = 1}^{n} ( {t}_{i} E S T P N {L}_{i} ) - {\sum }_{i = 1}^{n} {t}_{i} * {\sum }_{i = 1}^{n} E S T P N {L}_{i}}{n * {\sum }_{i = 1}^{n} {t}_{i}^{2} - {( {\sum }_{i = 1}^{n} {t}_{i} )}^{2}}$$

Where “i” is the sequence number in the transaction history for the observation period and “n” is the number of observations for the period (number of transactions).

In other embodiments, forecast component 108 can predict the financial distress rating based on trigger situations or special events. Trigger situations can include holidays, weekends, special events (weddings, giving birth, etc) that can increase the amount of spending that might cause financial distress to the user. The forecast component 108 can calculate the financial distress rating based on a function of the type of special event, the amount of increased consumer activity, mobile traffic (i.e., search history, browsing activity, and other data usage) and the funds balance of the user.

Turning now to FIG. 2, illustrated is a block diagram of an example, non-limiting embodiment of a financial distress calculation system 200 in accordance with various aspects described herein. System 200 includes a financial distress calculator 202 that forecasts the likelihood that a mobile device account associated with a mobile device (e.g., mobile device 110) will experience financial distress.

The retrieval component 204 can retrieve transaction information associated with the mobile device account from financial institution 210. The transaction information can include information and records about financial institution 210 account transfers and deposits. Payments made by credit cards, funds transfers by banks, and other transfers made to or from financial institutions 210 can be tracked and monitored by retrieval component 204.

The transaction history collected by retrieval component 204 can be used to track and to build a better understanding of purchasing and shopping habits by the user of the mobile device account. The transaction history can also provide some information about the expenditures made by the user as well as the user's income level based on deposits into the accounts from the user's employers and other benefactors.

The profile component 206 can analyze the transaction history and generate a profile of the mobile device account user or match the profile to one or more standard profiles. The profile can be based on the transaction history and also on information retrieved from the mobile device account (e.g., user provided account information).

Forecast component 208 can determine the financial distress rating for the mobile device account based on the transaction information retrieved from the financial institution 210 and the profile/contextual information. The financial distress rating can indicate the likelihood of the user defaulting on payments, or experiencing other forms of financial distress. The financial distress rating can also be time-based, where the forecast component 208 predicts when and for how long the period of financial distress is likely to happen. The financial distress rating can also indicate the severity or intensity of the financial distress. A lower rating may indicate that the user will merely have to make lifestyle changes to reduce costs or ‘belt-tighten’ their expenses. A higher rating may indicate that the user is likely to default on debt payments, mortgage payments, mobile device account fees, and other payments for services

Turning now to FIG. 3, a block diagram illustrating an example, non-limiting embodiment of a mobile device location system 300 in accordance with various aspects described herein is shown.

The mobile network (e.g., mobile network 112) can locate mobile device 302 using a technique called multilateration that requires at least two antennas/macrocells (304 and 308). More than 2 antennas can be used as well, which increases the accuracy of the location. Antennas 304 and 308 can have overlapping coverage areas 306 and 310. Mobile device 302, can be located in an area that is covered by antennas 304 and 308, can send and receive communication signals from each of the two macrocells.

The antennas 304 and 308 can be configured to send out regular signals that can be received by mobile devices in range of the antennas. The signals can be received and processed by the mobile devices independent of a call. In this way, the network based locating system can operate using network overhead resources that can be cheaper and less resource intensive than communications sent over an application layer data link.

The mobile network can also detect movement and speed of the mobile devices as they move and interpret the movement as movement on a map. A directed graph can be envisioned, where roads (e.g., 312) are edges and crossroads (e.g., 314) are nodes on the directed graph. This simplification can make interpreting the road rules complicated by it simplifies and facilitates further calculations of determining speed and direction of the mobile devices. Roads with traffic in both directions in such a graph are represented by a pair of edges. The edges are mathematical representations of the road. Several factors can be taken into consideration when calculating the correlation between the location coordinates and the road. 1) Distance from the point to the geometry of the edges. 2) Coincidence of two directions of traffic. 3) Change the direction of the vehicle—the probability that the car will roll off the main road in the general case is less than the probability that it will continue to move on the road. 4) Physical possibility of switching from one edge to another.

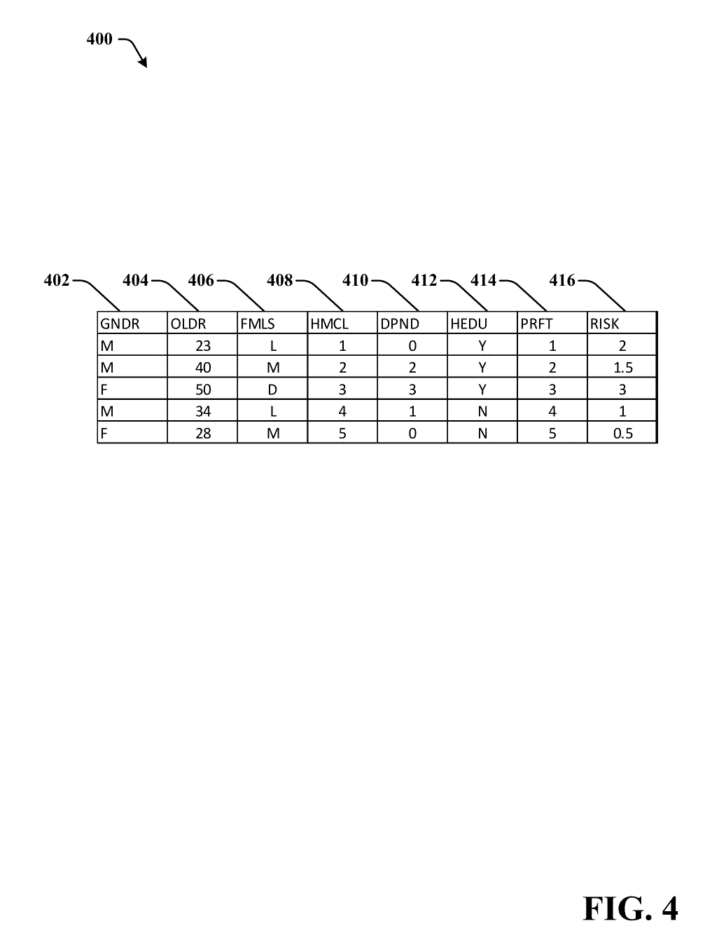

FIG. 4 is a block diagram illustrating a, non-limiting embodiment of an exemplary profile table 400 that facilitates making financial distress forecasts in accordance with various aspects described herein. Profile table 400 can be generated by a profile component (e.g., 106, 206) and based on the profile information, a forecast component (e.g., 108, 208) can assign a risk multiplier/rating to each of the entries.

In an exemplary embodiment, profile table 400 includes entries for several users, with information filled out for each of the categories 402-414. Gender column 402 contains information identifying whether the user is male (indicated by “M” or “F”). OLDR column 404 indicates the age of the user, and FMLS column 406 indicated the marital status of the user—“L” for single, “M” for married, and “D” for divorced. HMCL column 408 provides a rating of the relative residential class of the user. The rating can be from 1-5 where 1 is entry level and 5 is luxurious. DPND column 410 indicates the number of dependents/children the user has and HEDU column 412 indicates whether the user has a higher education. In some embodiments, higher education can be defined as an undergraduate degree, and in other embodiments, higher education can include graduate school and/or professional degrees. PRFT column 414 indicates the relative income level of the user with a range from 1-5 (lowest to highest). In other embodiments, other columns maybe added or subtracted from the profile table 400.

Based on the entries determined by the profile component 106 or 206, the forecast component 108 or 208 can assign a risk rating to the entries. For instance, somebody who has several dependents, lives in a relatively luxurious residence, and has a low income is going to have an increased probability of financial distress than somebody with fewer children, a more modest living quarters, and a higher income.

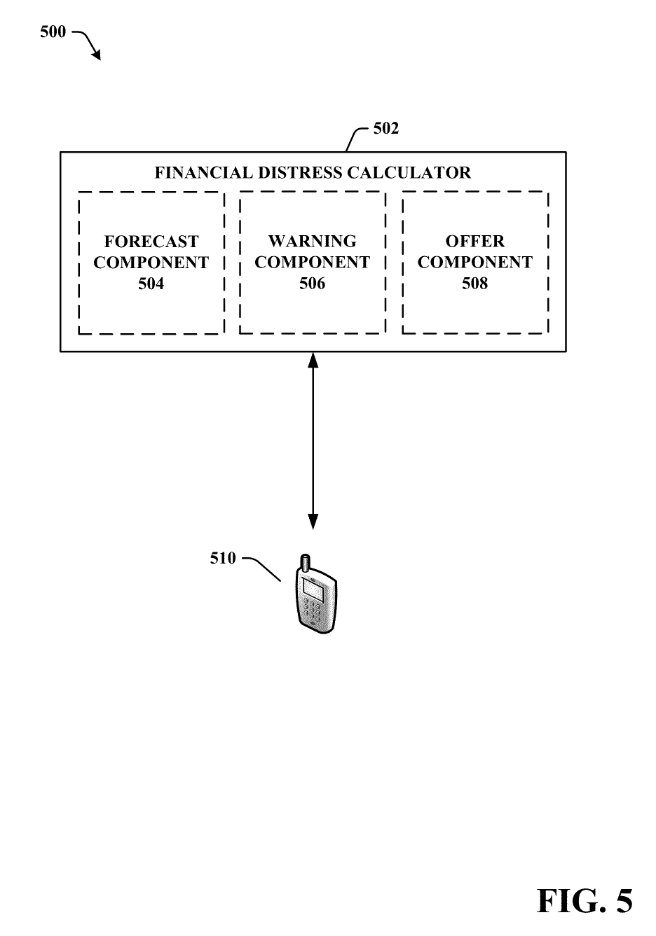

Turning now to FIG. 5, a block diagram illustrating an example, non-limiting embodiment of system 500 that issues warnings and makes offers based on a financial distress rating in accordance with various aspects described herein. The financial distress calculator 502 can include a warning component 506 and an offer component 508 that act on the financial distress ratings determined by forecast component 504.

The warning component 506 can be configured to issue a warning to the mobile device 510 or account associated with mobile device 110 if the financial distress rating exceeds a predetermined threshold. Whenever the forecast component 504 determines a likelihood of financial distress, the warning component 506 can issue the warning to give the user time to modify their behavior in order potentially avoid the financial distress. The threshold at which the warning component 506 issues the warning can be user defined, or can be automatically determined. The threshold can also be variable, depending on how serious or severe the financial distress is determined to be. For instance, if the forecast component 504 determines that the financial distress is likely to be very serious, possibly resulting in default, or bankruptcy, the warning component 506 can issue the warning very early, leaving the user plenty of time to modify behavior to avoid the financial distress.

The offer component 508 can be configured to generate an offer for either a service or a product to the mobile device 510 or account associated with mobile device 510 based on the financial distress rating. For instance, overdraft protection, short term loans, and other financial services can be offered to customers that are facing a period of financial distress. Other items such as luxury goods and services can be offered to the user if the financial distress rating is very low.

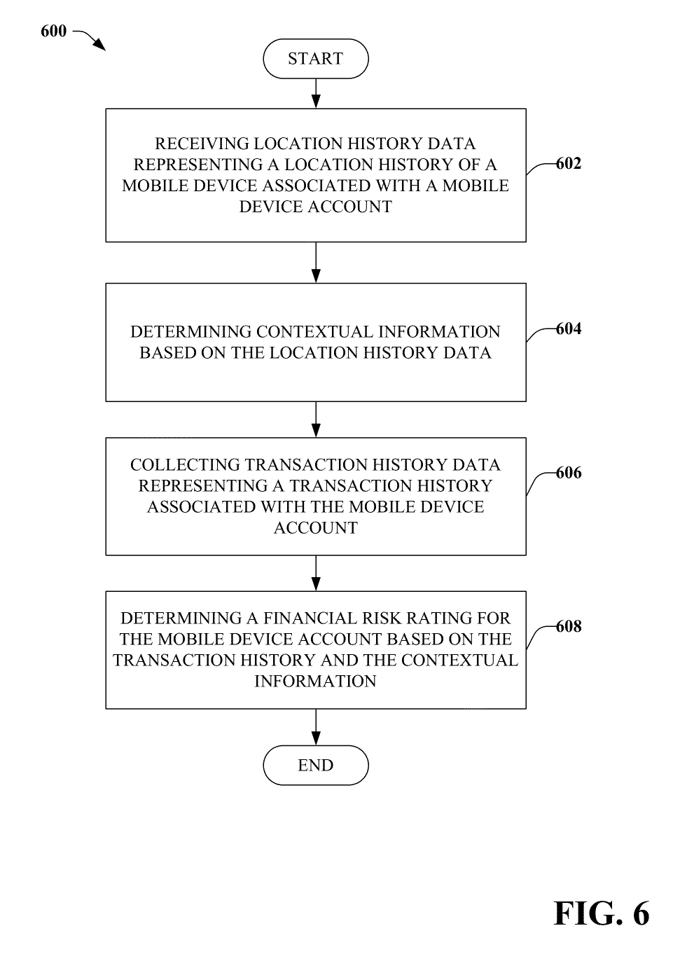

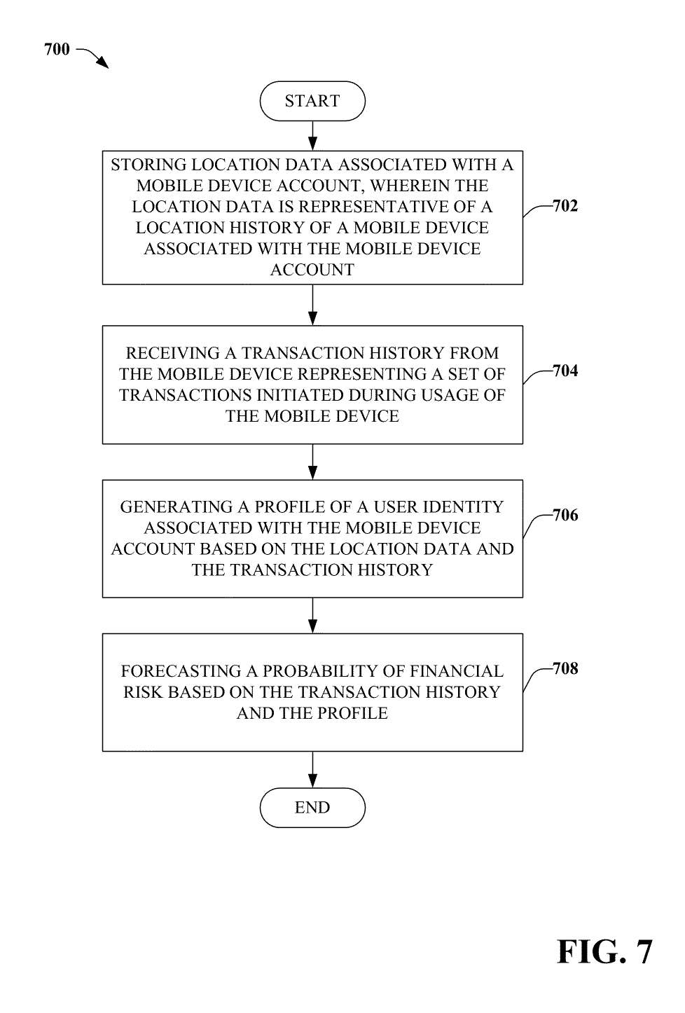

In view of the example systems 100-500 described above, methods that may be implemented in accordance with the described subject matter may be better appreciated with reference to the flow charts of FIGS. 6 and 7. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 6, illustrated is an example methodology 600 for forecasting financial distress. At step 602, location history data is received (e.g., by retrieval component 104 and/or 204) that represents a location history of a mobile device (e.g., mobile device 110) associated with a mobile device account. The location history can also include information indicating the speed and movement of the mobile device over time. At step 604, contextual information based on the location history data is determined (e.g., by profile component 106). The contextual information can also include information about the user of the mobile device account relating to type of occupation, hours worked, commute length, frequency of shopping excursions, duration of shopping excursions, vacations, and etc. The locations of the shopping excursions can be determined and estimates can be made about how much money is spent. For instance, if the mobile device is tracked to a grocery store, assumptions about expenditures will be different than if the mobile device is tracked to an area with many stores selling luxury items.

At step 606, data representing a transaction history associated with the mobile device account can be collected (e.g., by retrieval component 104 or 204). The transaction information can include information related to search requests made by the user, browsing history, online purchases, planned purchases, and financial institution account transfers and deposits. In some embodiments, the mobile network can track the data usage made by mobile device when utilizing mobile network, e.g., when mobile device is using 3G or 4G network services. The transaction history can also be collected from financial institutions associated with the mobile device account.

At 608, a financial risk rating can be determined (e.g., by forecast component 108 and/or 208) for the mobile device account based on the transaction history and the contextual information. The financial risk rating can indicate the likelihood of the user defaulting on payments, or experiencing other forms of financial distress. The financial risk rating can also be time-based, and predicts when and for how long the period of financial distress is likely to happen. The financial risk rating can also indicate the severity or intensity of the financial distress. A lower rating may indicate that the user will merely have to make lifestyle changes to reduce costs or ‘belt-tighten’ their expenses. A higher rating may indicate that the user is likely to default on debt payments, mortgage payments, mobile device account fees, and other payments for services.

Turning now to FIG. 7, a flow diagram of an example, non-limiting embodiment of a method 700 for forecasting financial distress as described herein is shown. Methodology 700 can begin at step 702, where location data associated with a mobile device account is stored (e.g., by retrieval component 104 and/or 204) wherein the location data is representative of a location history of the mobile device (e.g., mobile device 110) associated with a mobile device account. The location history can also include information indicating the speed and movement of the mobile device over time.

At 704, transaction history can be received from the mobile device (e.g., by retrieval component 104 or 204), wherein the transaction history represents a set of transactions initiated during usage of the mobile device. The transaction information can include information related to search requests made by the user, browsing history, online purchases, planned purchases, and financial institution account transfers and deposits. In some embodiments, the mobile network can track the data usage made by mobile device when utilizing mobile network, e.g., when mobile device is using 3G or 4G network services. The transaction history can also be collected from financial institutions associated with the mobile device account.

At 706, a profile of the mobile device account based on the location data and the transaction history can be generated (e.g., by profile component 106 and/or 206). The profile can be based on the contextual information and also on information retrieved from the mobile device account (e.g., user provided account information). The profile can include information about the user such as gender, age, marital status, number of marriages, type of residence, location of residence, number of dependents/children, education level, income level, tendency to save/saving ratio, number of vehicles in use, and other pertinent information. Some the profile categories can be determined based on the account information, some of it can be determined based on the location and contextualization data, some of it can be determined from an analysis of the transaction history, and the rest of the categories can be assumed or extrapolated based on the rest of the profile.

At 708, a probability of financial risk based on the transaction history and the profile can be forecast (e.g., by forecast component 108 and/or 208). The profiles can provide the framework of a risk model for the risk forecasting and the transaction histories can be fed into the framework to provide the probability of financial risk. The financial risk probability can indicate the likelihood of the user defaulting on payments, or experiencing other forms of financial distress.

### Example Computing Environment

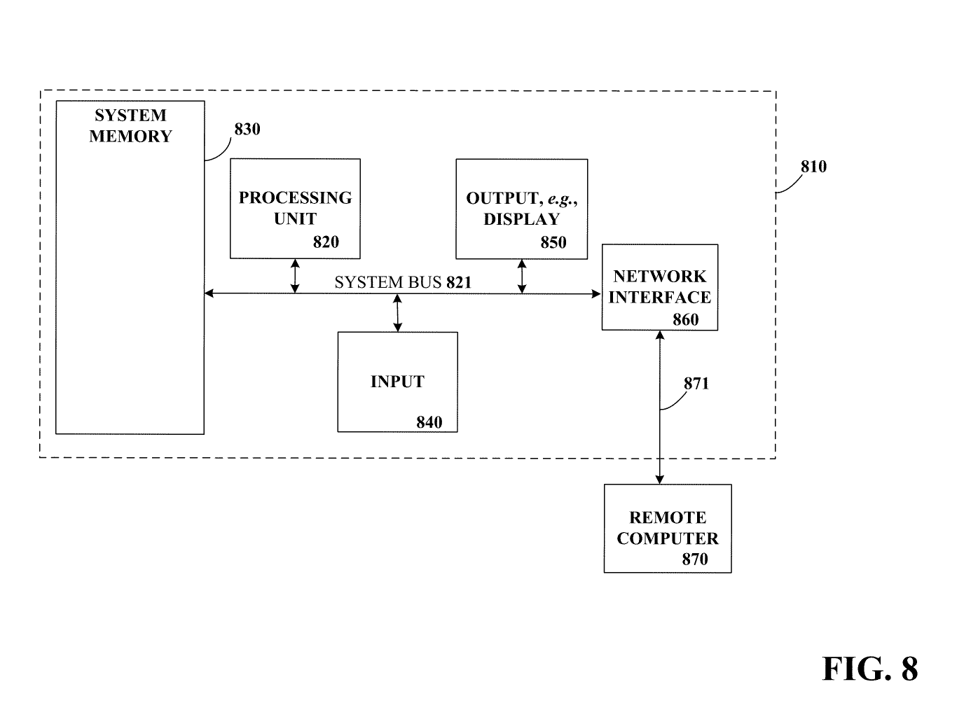

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 8 is but one example, and the disclosed subject matter can be implemented with any client having network/bus interoperability and interaction. Thus, the disclosed subject matter can be implemented in an environment of networked hosted services in which very little or minimal client resources are implicated, e.g., a networked environment in which the client device serves merely as an interface to the network/bus, such as an object placed in an appliance.

Although not required, some aspects of the disclosed subject matter can partly be implemented via an operating system, for use by a developer of services for a device or object, and/or included within application software that operates in connection with the component(s) of the disclosed subject matter. Software may be described in the general context of computer executable instructions, such as program modules or components, being executed by one or more computer(s), such as projection display devices, viewing devices, or other devices. Those skilled in the art will appreciate that the disclosed subject matter may be practiced with other computer system configurations and protocols.

FIG. 8 thus illustrates an example of a suitable computing system environment 800 in which some aspects of the disclosed subject matter can be implemented, although as made clear above, the computing system environment 800 is only one example of a suitable computing environment for a device and is not intended to suggest any limitation as to the scope of use or functionality of the disclosed subject matter. Neither should the computing environment 800 be interpreted as having any dependency or requirement relating to any one or combination of components illustrated in the exemplary operating environment 800.

With reference to FIG. 8, an exemplary device for implementing the disclosed subject matter includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures.

Computer 810 typically includes a variety of computer readable media. Computer readable media can be any available media that can be accessed by computer 810. By way of example, and not limitation, computer readable media can comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules, or other data in a modulated data signal such as a carrier wave or other transport mechanism and includes any information delivery media.

The system memory 830 may include computer storage media in the form of volatile and/or nonvolatile memory such as read only memory (ROM) and/or random access memory (RAM). A basic input/output system (BIOS), containing the basic routines that help to transfer information between elements within computer 810, such as during start-up, may be stored in memory 830. Memory 830 typically also contains data and/or program modules that are immediately accessible to and/or presently being operated on by processing unit 820. By way of example, and not limitation, memory 830 may also include an operating system, application programs, other program modules, and program data.

The computer 810 may also include other removable/non-removable, volatile/nonvolatile computer storage media. For example, computer 810 could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A hard disk drive is typically connected to the system bus 821 through a non-removable memory interface such as an interface, and a magnetic disk drive or optical disk drive is typically connected to the system bus 821 by a removable memory interface, such as an interface.

A user can enter commands and information into the computer 810 through input devices such as a keyboard and pointing device, commonly referred to as a mouse, trackball, or touch pad. Other input devices can include a microphone, joystick, game pad, satellite dish, scanner, wireless device keypad, voice commands, or the like. These and other input devices are often connected to the processing unit 820 through user input 840 and associated interface(s) that are coupled to the system bus 821, but may be connected by other interface and bus structures, such as a parallel port, game port, or a universal serial bus (USB). A graphics subsystem can also be connected to the system bus 821. A projection unit in a projection display device, or a HUD in a viewing device or other type of display device can also be connected to the system bus 821 via an interface, such as output interface 850, which may in turn communicate with video memory. In addition to a monitor, computers can also include other peripheral output devices such as speakers which can be connected through output interface 850.

The computer 810 can operate in a networked or distributed environment using logical connections to one or more other remote computer(s), such as remote computer 870, which can in turn have media capabilities different from device 810. The remote computer 870 can be a personal computer, a server, a router, a network PC, a peer device, personal digital assistant (PDA), cell phone, handheld computing device, a projection display device, a viewing device, or other common network node, or any other remote media consumption or transmission device, and may include any or all of the elements described above relative to the computer 810. The logical connections depicted in FIG. 8 include a network 871, such local area network (LAN) or a wide area network (WAN), but can also include other networks/buses, either wired or wireless. Such networking environments are commonplace in homes, offices, enterprise-wide computer networks, intranets and the Internet.

When used in a LAN networking environment, the computer 810 can be connected to the LAN 871 through a network interface or adapter. When used in a WAN networking environment, the computer 810 can typically include a communications component, such as a modem, or other means for establishing communications over the WAN, such as the Internet. A communications component, such as wireless communications component, a modem and so on, which can be internal or external, can be connected to the system bus 821 via the user input interface of input 840, or other appropriate mechanism. In a networked environment, program modules depicted relative to the computer 810, or portions thereof, can be stored in a remote memory storage device. It will be appreciated that the network connections shown and described are exemplary and other means of establishing a communications link between the computers can be used.

### Example Networking Environment

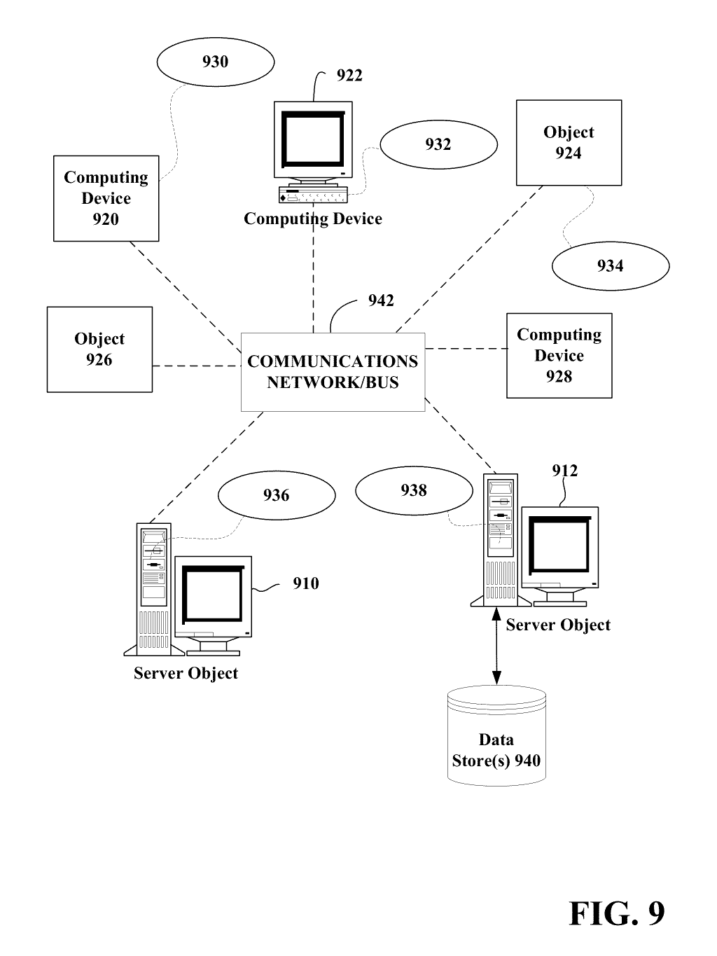

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938 and data store(s) 940. It can be appreciated that computing objects 910, 912, etc. and computing objects or devices 920, 922, 924, 926, 928, etc. may comprise different devices such as a mobile phone, personal digital assistant (PDA), audio/video device, MP3 players, personal computer, laptop, etc.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 942, either directly or indirectly. Even though illustrated as a single element in FIG. 9, communications network 942 may comprise other computing objects and computing devices that provide services to the system of FIG. 9, and/or may represent multiple interconnected networks, which are not shown. Each computing object 910, 912, etc. or computing object or devices 920, 922, 924, 926, 928, etc. can also contain an application, such as applications 930, 932, 934, 936, 938, that might make use of an API, or other object, software, firmware and/or hardware, suitable for communication with or implementation of the techniques and disclosure described herein.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems automatic diagnostic data collection as described in various embodiments herein.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service, in some cases without having to “know” any working details about the other program or the service itself.

In a client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc., acting as servers provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 942 or bus is the Internet, for example, the computing objects 910, 912, etc. can be Web servers with which other computing objects or devices 920, 922, 924, 926, 928, etc. communicate via any of a number of known protocols, such as the hypertext transfer protocol (HTTP). Computing objects 910, 912, etc. acting as servers may also serve as clients, e.g., computing objects or devices 920, 922, 924, 926, 928, etc., as may be characteristic of a distributed computing environment.

### Example Mobile Network Platform

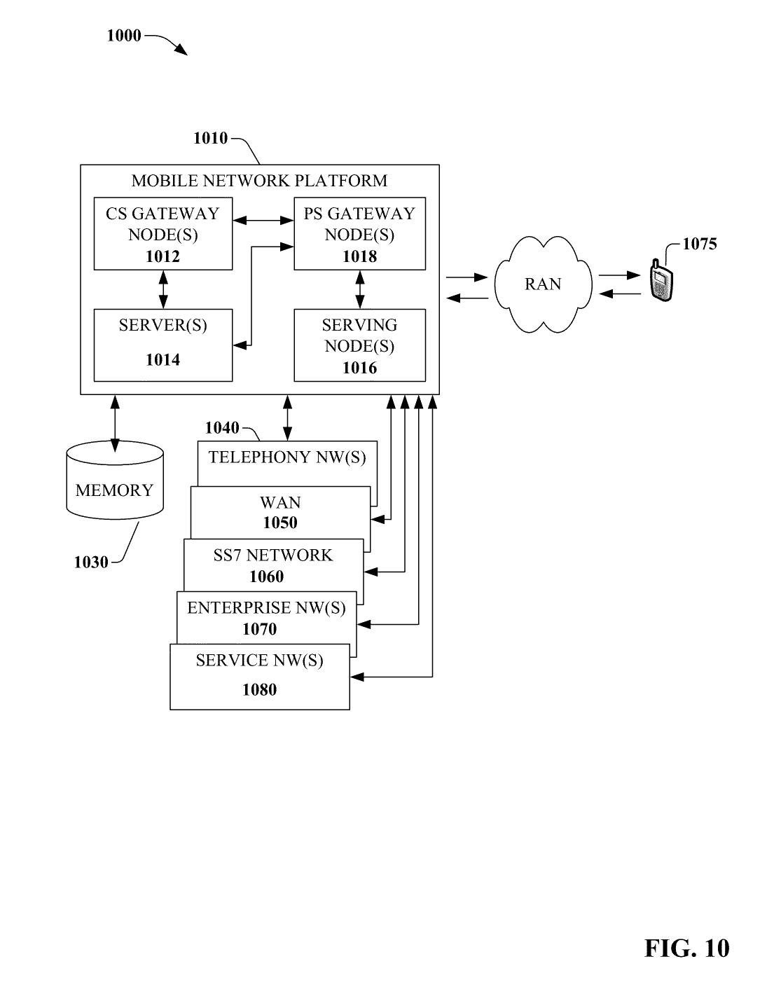

FIG. 10 presents an example embodiment 1000 of a mobile network platform 1010 that can implement and exploit one or more aspects of the disclosed subject matter described herein. Generally, wireless network platform 1010 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 1010 can be included in telecommunications carrier networks, and can be considered carrier-side components as discussed elsewhere herein. Mobile network platform 1010 includes CS gateway node(s) 1012 which can interface CS traffic received from legacy networks like telephony network(s) 1040 (e.g., public switched telephone network (PSTN), or public land mobile network (PLMN)) or a signaling system #7 (SS7) network 1070. Circuit switched gateway node(s) 1012 can authorize and authenticate traffic (e.g., voice) arising from such networks. Additionally, CS gateway node(s) 1012 can access mobility, or roaming, data generated through SS7 network 1070; for instance, mobility data stored in a visited location register (VLR), which can reside in memory 1030. Moreover, CS gateway node(s) 1012 interfaces CS-based traffic and signaling and PS gateway node(s) 1018. As an example, in a 3GPP UMTS network, CS gateway node(s) 1012 can be realized at least in part in gateway GPRS support node(s) (GGSN). It should be appreciated that functionality and specific operation of CS gateway node(s) 1012, PS gateway node(s) 1018, and serving node(s) 1016, is provided and dictated by radio technology(ies) utilized by mobile network platform 1010 for telecommunication.

In addition to receiving and processing CS-switched traffic and signaling, PS gateway node(s) 1018 can authorize and authenticate PS-based data sessions with served mobile devices. Data sessions can include traffic, or content(s), exchanged with networks external to the wireless network platform 1010, like wide area network(s) (WANs) 1050, enterprise network(s) 1070, and service network(s) 1080, which can be embodied in local area network(s) (LANs), can also be interfaced with mobile network platform 1010 through PS gateway node(s) 1018. It is to be noted that WANs 1050 and enterprise network(s) 1060 can embody, at least in part, a service network(s) like IP multimedia subsystem (IMS). Based on radio technology layer(s) available in technology resource(s) 1017, packet-switched gateway node(s) 1018 can generate packet data protocol contexts when a data session is established; other data structures that facilitate routing of packetized data also can be generated. To that end, in an aspect, PS gateway node(s) 1018 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 1000, wireless network platform 1010 also includes serving node(s) 1016 that, based upon available radio technology layer(s) within technology resource(s) 1017, convey the various packetized flows of data streams received through PS gateway node(s) 1018. It is to be noted that for technology resource(s) 1017 that rely primarily on CS communication, server node(s) can deliver traffic without reliance on PS gateway node(s) 1018; for example, server node(s) can embody at least in part a mobile switching center. As an example, in a 3GPP UMTS network, serving node(s) 1016 can be embodied in serving GPRS support node(s) (SGSN).

For radio technologies that exploit packetized communication, server(s) 1014 in wireless network platform 1010 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 1010. Data streams (e.g., content(s) that are part of a voice call or data session) can be conveyed to PS gateway node(s) 1018 for authorization/authentication and initiation of a data session, and to serving node(s) 1016 for communication thereafter. In addition to application server, server(s) 1014 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 1010 to ensure network's operation and data integrity in addition to authorization and authentication procedures that CS gateway node(s) 1012 and PS gateway node(s) 1018 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to wireless network platform 1010 (e.g., deployed and operated by the same service provider), such as femto-cell network(s) (not shown) that enhance wireless service coverage within indoor confined spaces and offload RAN resources in order to enhance subscriber service experience within a home or business environment by way of UE 1075.

It is to be noted that server(s) 1014 can include one or more processors configured to confer at least in part the functionality of macro network platform 1010. To that end, the one or more processor can execute code instructions stored in memory 1030, for example. It is should be appreciated that server(s) 1014 can include a content manager 1015, which operates in substantially the same manner as described hereinbefore.

In example embodiment 1000, memory 1030 can store information related to operation of wireless network platform 1010. Other operational information can include provisioning information of mobile devices served through wireless platform network 1010, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1030 can also store information from at least one of telephony network(s) 1040, WAN 1050, enterprise network(s) 1060, or SS7 network 1070. In an aspect, memory 1030 can be, for example, accessed as part of a data store component or as a remotely connected memory store.

As used herein, the term “text message” is used to mean a brief electronic message that is sent to or from a mobile device over a mobile network. SMS messages are one form of text message using a standardized protocol. Other communication protocols sending electronic messages over mobile networks are also covered by this disclosure.

Reference throughout this specification to “one embodiment,” “an embodiment,” “a disclosed aspect,” or “an aspect” means that a particular feature, structure, or characteristic described in connection with the embodiment or aspect is included in at least one embodiment or aspect of the present disclosure. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in various disclosed embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers. Further, these components can execute from various non-transitory computer-readable media having various data structures stored thereon. In this regard, the terms “non-transitory” and “tangible” herein as applied to storage, memory or computer-readable media, is to be understood to exclude only propagating transitory signals per se as a modifier and does not relinquish all standard storage, memory or computer-readable media that are not only propagating transitory signals per se.

The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary,” “demonstrative,” or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A system, comprising:
a memory to store computer-executable instructions; and
a processor, communicatively coupled to the memory, which facilitates execution of the computer-executable instructions to at least:
receive location data associated with a mobile device account;
determine contextual information based on the location data;
receive transaction information associated with the mobile device account; and
determine a financial distress rating for the mobile device account based on the transaction information and the contextual information.

2. The system of claim 1, wherein the transaction information is received from a mobile device associated with the mobile device account.

3. The system of claim 1, wherein the transaction information is received from a financial institution account associated with the mobile device account.

4. The system of claim 1, wherein the processor further facilitates the execution of the computer-executable instructions to generate a profile for a mobile device associated with the mobile device account based on the contextual information and the transaction information, wherein the profile includes a risk multiplier based on a value in the profile.

5. The system of claim 4, wherein the financial distress rating is determined based on a comparison of the transaction information to the profile.

6. The system of claim 4, wherein the profile includes information about a user identity associated with the mobile device account comprising at least one of a gender, an age, a marital status, a number of marriages, a residence class, a residence location, a number of dependents, an education level, an income level, a relative savings tendency value, a number of vehicles, or a type of vehicle.

7. The system of claim 1, wherein the processor further facilitates the execution of the computer-executable instructions to determine a residential location of a user identity associated with the mobile device account based on the location data.

8. The system of claim 1, wherein the contextual information includes information about a user identity associated with the mobile device account comprising at least one of an occupation, a number of hours worked, a commute length, a frequency of shopping excursions, or a duration of a shopping excursion.

9. The system of claim 1, wherein the transaction information includes information related to at least one of search requests initiated from a mobile device associated with the mobile device account, a browsing history of the mobile phone, online purchases initiated from the mobile phone, planned purchases initiated from the mobile phone, and financial institution account transfers and deposits initiated from the mobile phone.

10. The system of claim 1, wherein the processor further facilitates the execution of the computer-executable instructions to send a warning message to an address associated with a user identity of the mobile device account in response to the financial distress rating being determined to exceed a threshold rating for the user identity.

11. The system of claim 1, wherein the processor further facilitates the execution of the computer-executable instructions to generate an offer for at least one of a service or a product to a user identity of the mobile device account based on the financial distress rating.

12. A method, comprising:
receiving, by a system comprising at least one processor, location history data representing a location history of a mobile device associated with a mobile device account;
determining, by the system, contextual information based on the location history data;
collecting, by the system, transaction history data representing a transaction history associated with the mobile device account; and
determining, by the system, a financial risk rating for the mobile device account based on the transaction history data and the contextual information.

13. The method of claim 12, further comprising:
collecting, by the system, the transaction history data from browsing history data associated with usage of a browser on the mobile device.

14. The method of claim 12, further comprising:
collecting, by the system, the transaction history data from device associated with a financial institution associated with the mobile device account.

15. The method of claim 12, further comprising:
generating, by the system, profile data representing a profile of a user identity associated with the mobile device account based on the contextual information and transaction history data, wherein the profile data includes a risk multiplier value based on a value in the profile.

16. The method of claim 15, wherein the determining the financial risk rating is based on comparing the transaction history data to the profile data.

17. The method of claim 15, wherein the generating the profile data includes determining information associated with the user identity relating to at least one of a gender, an age, a marital status, a number of marriages, a residential class, a number of dependents, an education level, an income level, a value representing a tendency to save, a number of vehicles or a type of vehicle.

18. The method of claim 12, wherein the determining the contextual information further comprises determining information relating to a user identity associated with the mobile device account about at least one of an occupation, a number of hours worked, a commute length, a frequency of shopping excursions, or a duration of a shopping excursion.

19. The method of claim 12, further comprising:
sending, by the system, an alert to the mobile device account in response to the financial risk rating being determined to satisfy a threshold function.

20. The method of claim 12, further comprising:
generating, by the system, an offer for at least one of a service or a product for a user identity associated with the mobile device account based on the financial risk rating.

21. A tangible computer-readable storage device comprising computer-executable instructions that, in response to execution, cause a system comprising a processor to perform operations, comprising:
storing location data associated with a mobile device account, wherein the location data is representative of a location history of a mobile device associated with the mobile device account;
receiving a transaction history from the mobile device representing a set of transactions initiated during usage of the mobile device;
generating a profile of a user identity associated with the mobile device account based on the location data and the transaction history; and
forecasting a probability of financial risk based on the transaction history and the profile.

22. The tangible computer-readable storage device of claim 21, wherein the operations further comprise:
sending a warning to an address associated with the user identity in response to the probability of financial risk satisfying a defined criterion.

23. The tangible computer-readable storage device of claim 21, wherein the operations further comprise:
generating an offer for the user identity relating to at least one of a service or a product for potential use by the mobile device based on the financial distress rating.

24. The tangible computer-readable storage device of claim 21, wherein the profile includes a set of categories with a set of risk multipliers corresponding to the set of categories, wherein the set of risk multipliers are based on values in corresponding categories of the set of categories.

25. The tangible computer-readable storage device of claim 24, wherein the set of categories include at least two of gender, age, marital status, number of marriages, residence class, residence location, number of dependents, education level, income level, relative savings tendency, number of vehicles or type of vehicle.

26. The tangible computer-readable storage device of claim 21, wherein the forecasting the probability of financial risk is based at least in part on a special event.

27. The tangible computer-readable storage device of claim 26, wherein the trigger event includes an occurrence of a holiday or a weekend.
